(19) United States
(12) Patent Application Publication
(10) Pub. No.: US 2004/0086715 A1
(43) Pub. Date: May 6, 2004

(54) Synthetic resin film for color copying or printing

(76) Inventor: Shin Nakashima, Nara-shi (JP)

Correspondence Address: JORDAN AND HAMBURG LLP, 122 EAST 42ND STREET, SUITE 4000, NEW YORK, NY, 10168, US

(21) Appl. No.: 10/658,967

(22) Filed: Sep. 9, 2003

(30) Foreign Application Priority Data
Nov. 1, 2002 (JP) 2002-320279

(51) Int. Cl. B32B 5/00

(52) U.S. Cl. 428/409; 428/411.1; 428/480; 428/689

(57) ABSTRACT

This invention provide a synthetic resin film for color copying or printing, the front surface of which is coated with anti-static agents so that the value of insulation electrical resistance of the front surface may be in the range of 9.99×10⁷ ohms to 1.00×10⁶ ohms, when measured in copying or printing circumference having the temperature of 20° C. and the humidity of 65%, and which can copy or print distinct color images without shading of images and disorder of the images on the front surface.

### BACKGROUND OF THE INVENTION

This invention relates to a synthetic resin film for color copying or printing, which is to be used by means of printing machines such as a photo-copy machine, laser printer, etc.

Quality of letters or images (Hereinafter referred to as images.) which were color-copied or color-printed on the surface of synthetic resin films depended on the temperature and the humidity in circumference in which copying or printing was carried out.

Namely, since the front and back surfaces of synthetic resin films were made of insulating materials, formerly, at least the front surface of the films was coated with well-known anti-static agents, so that the value of insulation electrical resistance of the front surface maight be 10⁸ to 10⁹ ohms, when measured in copying or printing circumference having the temperature of 20° C. and the humidity of 65%, for the purpose of preventing static elecricity due to friction from generating and of the films passing smoothly through color copying or printing machines.

However, as to the color images copied or printed on the surface of the films, disorder of images and disorder of the shading of images frequently occurred, even if the surface of the films was coated with anti-static agents.

### SUMMARY OF THE INVENTION

Then, as a result of profound study, this inventor has found that if the front surface of insulating synthetic resin films for color copying or color printing is coated with anti-static agents so that the value of insulation electrical resistance of the surface of the front surface may be in the range of 9.99×10⁷ ohms to 1.00×10⁶ ohms, when measured in copying or printing circumference having the temperature of 20° C. and the humidity of 65%, the synthetic resin films can obtain distinct images without shading of color images and disorder of color images, when copying or printing color images by means of printing machines such as photo-copying machine, laser printer, etc. Thus, this inventor completed this invention.

Namely, the present invention provides a synthetic resin film for color copying or printing which can obtain distinct images without shading of color images and disorder of color images, when copying or printing color images by means of printing machines such as photo-copying machine, laser printer, etc.

In the present invention, as to anti-static agents, particles of conductive materials such as particles of metals are to be used, so that the value of insulation elecytrical resistance of the front surface may be in the range of 9.99×10⁷ ohms to 1.00×10⁶ ohms, when measured in copying or printing circumference having the temperature of 20° C. and the humidity of 65%.

As to the anti-static agents in the present invention, fine matting particles, having an average grain size of 0.1 to 1.0 micron, of metals such as alloyed metals of tin and antimony, alloyed metals of iridium and tin, silver, alloyed metal of silver, etc. are used with well known coating solution, so that the value of insulation elecytrical resistance of the surface may be in the range of 9.99×10⁷ ohms to 1.00×10⁶ ohms, when measured in copying or printing circumference having the temperature of 20° C. and the humidity of 65%.

The value of insulation electrical resistance increases or decreases in accordance with the amount of the matting agents which are added. Also, the anti-static agents in the present invention can be mixed with interfacial active agents or well known anti-static agents made of synthetic resins.

Also, as to the synthetic resin film in the present invention, all of well known synthetic resin films for copying machines or laser printers, such as polyester films, polypropylene films, polynaphthalene films, etc. are included.

### BRIEF DESCRIPTION OF THE DRAWINGS

FIG. 1 is an enlarged sectional view of an example of the present invention.

FIG. 2 is an enlarged sectional view of another example of the present invention.

### DESCRIPTION OF THE PREFERRED EMBODIMENTS

### EXAMPLE 1

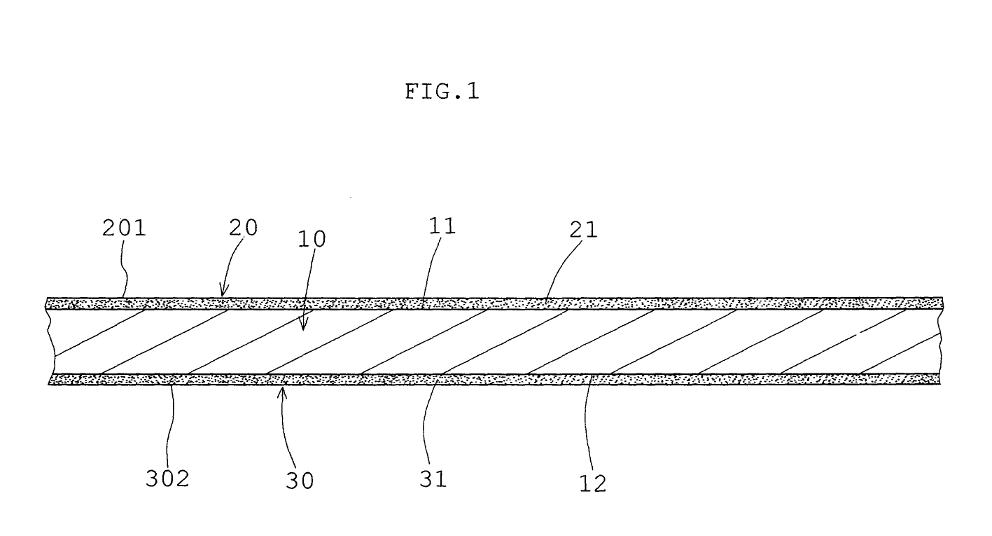

Referring to FIG. 1, to coat the front surface 11 of a polyester film 10 having the thickness of about 250 microns, per 1 square meter of the film, 1 kg of isopropyl alcohol, 5 g of fine matting particles 21 having an average grain size of 0.2 microns of an alloyed metal of tin and antimony and 0.1 to 0.9 g of saturated copolymerization polyester resin were mixed to obtain a mixture, and the mixture was adjusted so that the coefficient of viscocity maight be 800 cps. Further to the mixture, well known anti-static agents, which comprise 1 kg of isopropyl alcohol and 50 g of a copolymer of quaternary ammonium salt and acrylic monomer (ELECOND, PQ-50B made by Sohkenkagaku Co.) were blended. Then, the mixture coated the front surface 11 to form a layer of anti-static agents 20, after adjusted so that the value of insulation electrical resistance of the surface 201 of the layer of the anti-static agents 20 may be 2×10⁷ ohms, when measured in copying or printing circumference having the temperature of 20° C. and the humidity of 65%.

Also, to coat the back surface 12 of the polyester film 10, per 1 square meter of the film, 200 g of fine matting particles of silica 31 having an average grain size of 5 to 15 microns and 0.1 to 0.9 g of saturated copymer of polyester resin were mixed into 1 kg of isopropyl alcohol to obtain a mixture. Then, the mixture was adjusted so that coefficient of viscocity maight be 800 cps, and the mixture was blended into the foregoing well known anti-static agents 30 comprising 1 kg of isopropyl alcohol and 60 g of the foregoing copymer. Then, the mixture coated the back surface 12 of the polyester film 10 to form a layer of anti-static agents 30, after adjusted so that the value of insulation electrical resistance of the surface 302 of the layer of anti-static agents 30 maight be 4×10⁸ ohms, when measured in copying or printing circum-ference having the temperature of 20° C. and the humidity of 65%. Thus, a product according to Example 1 of the present invention was obtained.

### EXAMPLE 2

In the foregoing Example 1, to coat the back surface 12 of the polyester film 10, per 1 square meter of the film, 300 g of fine matting particles 31 were used, and respective values of insulation electrical resistance of the surface 201 of a layer of anti-static agents 20 and the surface 302 of a layer of anti-static agents 30 were adjusted to 2×10⁷ ohms and 2×10¹⁰ ohms, when measured in copying or printing circumference having the temperature of 20° C. and the humidity of 65%. Then, the product according to Example 2 was obtained.

### EXAMPLE 3

Referring to FIG. 1, to coat the front surface 11 of a polyester film 10 having the thickness of about 250 microns, per 1 square meter of the film, 1 kg of isopropyl alcohol, 5 g of fine matting particles 21 having an average grain size of 0.2 microns of an alloyed metal of tin and antimony and 0.1 to 0.9 g of saturated copolymerization polyester resin were mixed to obtain a mixture, and the mixture was adjusted so that coefficient of viscocity maight be 800 cps. Further to the mixture, well known anti-static agents 20, which comprise 1 kg of isopropyl alcohol and 50 g of a copolymer of quaternary ammonium salt and acrylic monomer (ELECOND, PQ-50B made by Sohkenkagaku Co.) were blended. Then, the mixture coated the front surface 11 to form a layer of anti-static agents 20, after adjusted so that the value of insulation electrical resistance of the surface 201 of the layer of anti-static agents 20 may be 2×10⁷ ohms, when measured in copying or printing circumference having the temperature of 20° C. and the humidity of 65%.

Also, to coat the back surface 12 of the polyester film 10, per 1 square meter of the film, 200 g of fine matting particles of silica 31 having an average grain size of 5 to 15 microns, 10 g of fine particles having an average grain size of 0.2 microns of an alloyed metal of tin and antimony and 0.1 to 0.9 g of saturated copymer of polyester resin were mixed into 1 kg of isopropyl alcohol to obtain a mixture. The mixture was adjusted so that coefficient of viscocity maight be 800 cps, and then, the mixture was blended into the foregoing well known anti-static agents comprising 1 kg of isopropyl alcohol and 60 g of the foregoing copymer. Then, the mixture coated the back surface 12 of the polyester film 10 to form a layer of anti-static agents 30, after adjusted so that the value of insulation electrical resistance of the surface 302 of the layer of anti-static agents 30 maight be 8×10⁷ ohms, when measured in copying or printing circumference having the temperature of 20° C. and the humidity of 65%.

Thus, a product according to Example 3 of the present invention was obtained.

### EXAMPLE 4

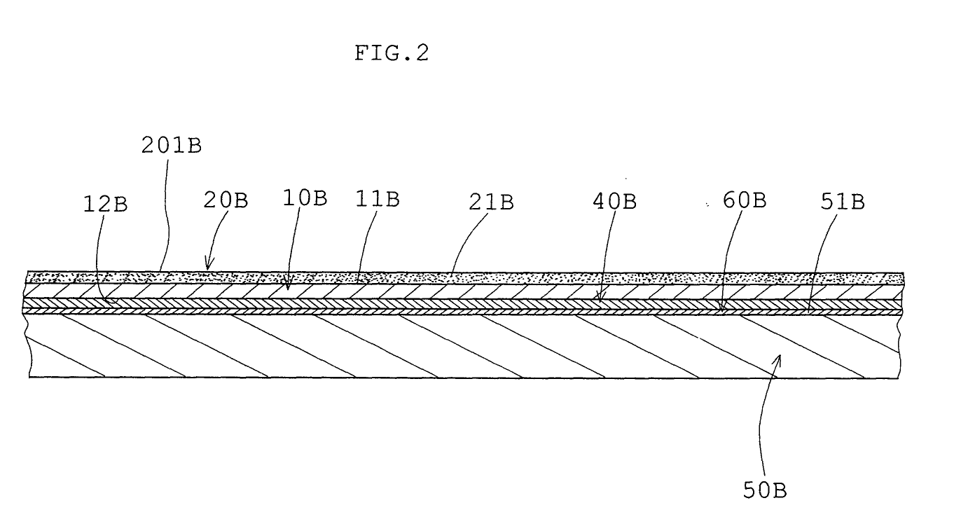

Referring to FIG. 2, to coat the front surface 11B of a polyester film 10B having the thickness of 75 microns, per 1 square meter of the film, 15 g of fine matting particles 21B having an average grain size of 0.2 microns of an alloyed metal of tin and antimony and 1 kg of isopropyl alcohol, were mixed to obtain a mixture. The mixture was mixed with 0.1 to 0.9 g of a satulated copymer polyester resin, and adjusted so that coefficient of viscocity maight be 800 cps. Then, the mixture and anti-static agents 20B which comprised 1 kg of isopropyl alcohol and 50 g of a copolymer of quaternary ammonium salt and an acrylic monomer (ELECOND PQ-10B made by Sohkenkagaku Co.) were blended. Then, the blended mixture coated the front surface 11B to form a layer of anti-static agents 20B, after adjusted so that value of insulation electrical resistance of the surface 201B of the layer of anti-static agents 20B maight be 2×10⁶ ohms, when measured in copying or printing circumference having the temperature of 20° C. and the humidity of 65%.

Also, to coat the back surface 12B of the polyester film 10B, pressure sensitive adhesive 40B (DF8320 made by Tohyo Ink Co.) and ethyl acetate were mixed to obtain a mixture. The mixture was adjusted so that the solid part maight be 40%, and so that coefficient of viscocity maight be about 4000 cps, and the mixture coated the back surface 12B.

Subsequently, the front surface 51B of a releasing paper 50B having the weight of 209.3 g/m² was coated with a layer of silicone coating 60B having the thickness of about 1 micron, and then, the releasing paper 50B was put on a layer of the pressure sensitive adhesive 40B. Thus, a product of Example 4 was obtained.

### Comparisons 1, 2 and 3

As comparisons with Example 1, Example 2 and Example 3, the value of electrical resistance of the surface 201 of a layer of the anti-static agent 20 and the value of insulation electrical resistance of the surface 302 of a layer of the anti-static agent 30 were adjusted to respective values shown in the following table.

Value of insulation
electrical resistance (ohms)

| | layer of agent 20 | layer of agent 30 |
|---|---|---|
| Comparison 1 | 4 × 10⁸ | 6 × 10⁹ |
| Comparison 2 | 3 × 10¹⁰ | 8 × 10¹¹ |
| Comparison 3 | 4 × 10⁹ | 5 × 10⁹ |

### Comparisons 4, 5 and 6

As comparisons with Example 4, the value of insulation electrical resistance of the surface 201B of a layer of the anti-static agent 20B was adjusted to respective values shown in the following table.

| | Value of insulation |
|---|---|
| | electrical resistance |
| | layer of agent 20B |
| Comparison 4 | 2 × 10⁹ |
| Comparison 5 | 3 × 10¹⁰ |
| Comparison 6 | 4 × 10¹² |

### Result of Printing

Tests of printing of black images on examples and comparisons were carried out by means of the same color laser printer. Result of the printing was shown in the following table.

| | Measured value | Evaluation |
|---|---|---|
| Example 1 | 100% | good |
| Example 2 | 100% | good |
| Example 3 | 100% | good |
| Example 4 | 100% | good |
| Comparison 1 | 70% | not good |
| Comparison 2 | 50% | not good |
| Comparison 3 | 60% | not good |
| Comparison 4 | 70% | not good |
| Comparison 5 | 60% | not good |
| Comparison 6 | 20% | not good |

Measured values and evaluation were carried out by means of color charts which Tokyo Process Industry Cooperative Association used.

### Advantages

As abovementioned, the front surface of the synthetic resin film for color copying or printing according to the present invention is coated with anti-static agents according to the invention so that the value of electrical resistance of the front surface may be in the range of 9.99×10⁷ ohms to 1.00×10⁶ ohms, and accordingly, the synthetic resin film can copy or print distinct color images, without disorder.

I claim:

1. A synthetic resin film for color copying or printing, characterized in that the front surface of a synthetic resin film is coated with anti-static agents so that the value of insulation electrical resistance of the front surface may be in the range of 9.99×10⁷ ohms to 1.00×10⁶ ohms, when measured in copying or printing circumference having the temperature of 20° C. and the humidity of 65%.

2. A synthetic resin film for color copying or printing, characterized in that the front surface of a synthetic resin film is coated with a mixture of fine matting particles of metals such as alloyed metals of tin and antimony, alloyed metals of iridium and tin, silver, alloyed metals of silver, etc. a solvent such as isopropyl alcohol, etc. and a coating solution such as a sutulated copolymerization polyester resin etc., so that the value of insulation electrical resistance of the front surface may be in the range of 9.99×10⁷ ohms to 1.00×10⁶ ohms, when measured in copying or printing circumference having the temperature of 20° C. and the humidity of 65% .

3. A synthetic resin film for color copying or printing as claimed in claim 2, wherein an interfacial active agent or an anti-static agent made of synthetic resins is added to the mixture.
